(19) United States
(12) Patent Application Publication
(10) Pub. No.: US 2014/0168806 A1
(43) Pub. Date: Jun. 19, 2014

(54) Disk Drive Write-Inhibit Control Using Adaptive PES Predictor

(71) Applicant: HGST NETHERLANDS B.V., Amsterdam (NL)

(72) Inventors: Abhishek Dhanda, San Jose, CA (US); Toshiki Hirano, San Jose, CA (US); Tetsuo Semba, San Jose, CA (US)

(73) Assignee: HGST NETHERLANDS B.V., Amsterdam (NL)

(21) Appl. No.: 13/717,168

(22) Filed: Dec. 17, 2012

(51) Int. Cl. G11B 27/36

(52) U.S. Cl. CPC G11B 27/36
USPC 360/31

(57) ABSTRACT

Disk drives are described with a write inhibit control system with an adaptive head position predictor, e. g. an adaptive FIR filter, that includes a set of coefficients (weights) that are updated for each iteration based on the difference between past predictions and actual location measurement. Standard PES signals are used as the measure of the actual head position. The adaptive head position predictor uses a sequence of the most recent PES measurements and a corresponding set of coefficients (weight values) to calculate a predicted (future) PES value during each iteration. The write inhibit decision is then made by determining whether either a) the absolute value of the current measured PES is less than predetermined value L; or b) the absolute value of the estimated future PES is less than predetermined value L.

### FIELD OF THE INVENTION

The invention relates to the field of disk drive design and operation and more particularly to means and methods for predicting head position for write-inhibit decisions.

### BACKGROUND

Hard disk drives can be subjected to a variety of a vibrations including those from a computer's speaker playing music. Vibrations present challenges to the servo system in keeping the heads accurately following the track on the rotating disk. Use of peak filters in the servo system is known to increase the vibration resistance. Peak filters increase gains for the vibration frequencies and diminish the effect of vibrations on the head servo control. In U.S. Pat. No. 8,059,356 to Sakagami, et al. (Nov. 15, 2011) a servo loop is described that includes a peak filter with a fixed peak frequency and a variable gain and an adaptive peak filter with a variable peak frequency and a variable gain. The filter controller is configured to control the gain of the adaptive peak filter according to the gain of the first peak filter.

One way of dealing with vibration is to include in the servo system write inhibit controls that include means for predicting a future position of the write head relative to the track in order to prevent writing if the head is expected to be off track. The write inhibit control is turned on if the predicted future location is outside the data track during a data write. FIG. 1 is an illustration of a write inhibit technique according to the prior art in which fixed models are used for generating estimated and predicted PES values. PES(k) is the measured PES at servo sector k. The predicted value for next servo sector EstPes(k+1) is generated. Prior art write inhibit technique is stop writing if either current PES(k) or predicted PES (EstPes(k+1)) exceeds a predetermined safe limit (L). The prior art predictor blocks use fixed filter plant equations. However, fixed filter plant equations are not flexible enough to adapt to different end-user conditions (e.g, different laptop brands, different music).

A variety of techniques have been described for estimating the future position of the head. For example, U.S. Pat. No. 7,558,016 to Le, et al. (Jul. 7, 2009) describes use of a Kalman filter with state modeling coefficients.

U.S. Pat. No. 7,453,660 to Tanner (Nov. 18, 2008) describes use of a shock sensor with feed forward adaptive filters. The shock sensor output signal can be filtered to pass signals through low and high for different shock channels. Mechanical disturbances may be compensated for during writing to a track on the disk drive as a function of the low frequency component. Higher frequency shocks may be processed on a separate shock channel to inhibit or allow write operations.

U.S. Pat. No. 6,958,882 to Kisaka (Oct. 25, 2005) describes use of a shock sensor with adaptive processing to obtain a feed forward signal. The signal of the shock sensor is limited by a bandpass filter which feeds an adaptive filter (FIR) where a feed forward control signal is generated. The FIR also receives a control signal from a function described as a parameter adaptation algorithm (PAA) that is said to adaptively obtain coefficients using a current head position and the phase shift filter output which is derived from bandpass filter. The feed forward signal is used together with a feedback control signal.

### SUMMARY OF THE INVENTION

Embodiments of invention include a disk drive with a write inhibit control system with an adaptive head position predictor, e. g. an adaptive FIR filter, that includes a set of coefficients (weights) that are updated for each iteration based on the difference between past predictions and actual location measurement. Standard PES signals are used as the measure of the actual head position. The adaptive head position predictor uses a sequence of the most recent PES measurements and a corresponding set of coefficients (weight values) to calculate a predicted (future) PES value during each iteration. The write inhibit decision is then made by determining whether either a) the absolute value of the current measured PES is less than predetermined value L; or b) the absolute value of the estimated future PES is less than predetermined value L. If both the current and predicted future PES values are less than the predetermined limit value L, then writing is allowed, otherwise writing is inhibited.

### BRIEF DESCRIPTION OF THE FIGURES

FIG. 1 is an illustration of a write inhibit technique according to the prior art.

FIG. 2A is a conceptual block diagram of a FIR adaptation system according to the invention.

FIG. 2B is a flowchart illustrating write-inhibit decisions using adaptive prediction according to an embodiment the invention.

FIG. 3 is a block diagram illustrating an adaptive FIR filter in an adaptive prediction write-inhibit system according to an embodiment the invention.

FIG. 4 are equations for updating the coefficients and the stability criterion for the learning rate of the LMS adaptation according to an embodiment the invention.

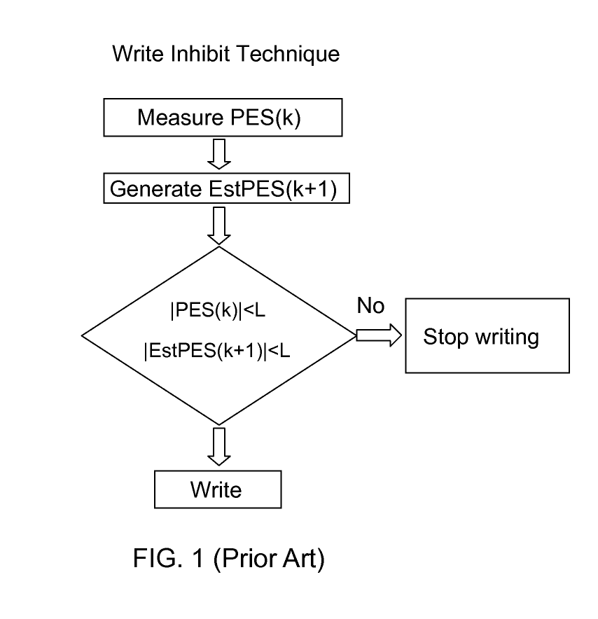

### DETAILED DESCRIPTION OF THE INVENTION

The adaptive predictor scheme according to the invention provides for more accurate prediction of head motion in high vibration environment. The adaptive FIR filter acts on current and previously saved PES samples. Filter coefficients are adjusted in real-time to match the transfer function between speaker/chassis and PES in order to minimize prediction error. In embodiments the learning rate is self-adjusted based on the inverse of moving average of PES variance (least mean squared (LMS) algorithm) for fast convergence.

Benefits of the invention include more accurate head position predictions for the write-inhibit decision, which provides a performance increase by decreasing the probability of a false or unnecessary write-inhibit event. Data integrity is also improved because there is less probability of adjacent track over-write which in turn increases data tracks per inch (TPI), i.e. reduced track over-write can be utilized for increasing data TPI. Embodiments of the invention can be implemented cost effectively by making only changes in firmware.

Experiments have demonstrated that embodiments of the invention improves prediction accuracy by 23-30% as compared to existing fixed model based schemes.

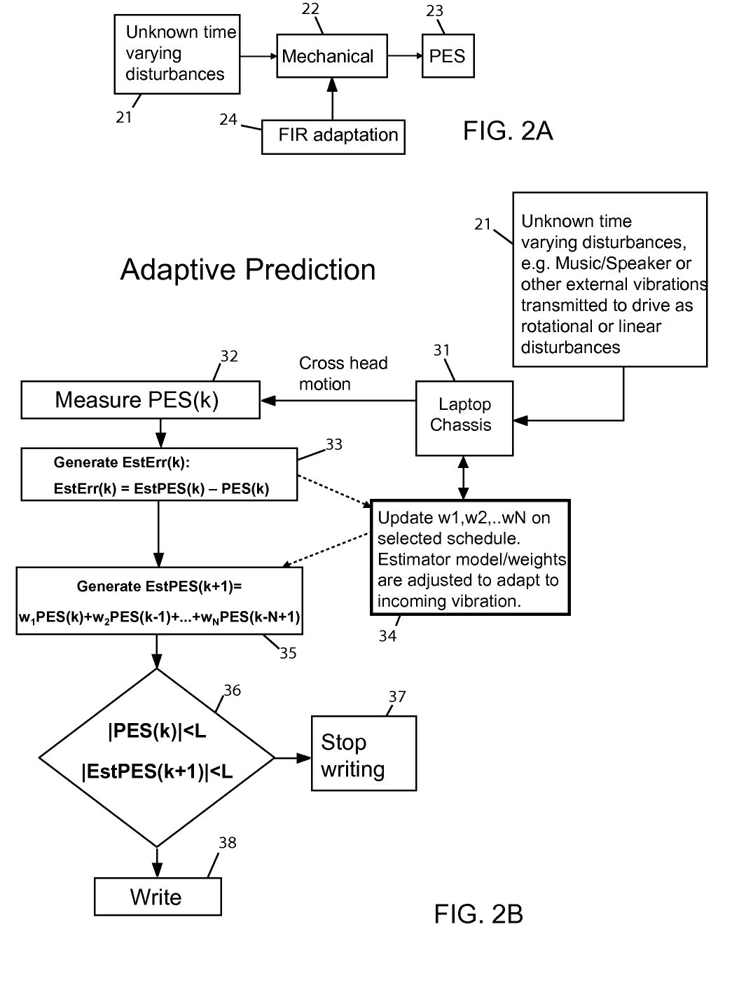

FIG. 2A is a conceptual block diagram of selected components in a FIR adaptation system according to the invention. The unknown time varying disturbances 21 become inputs into mechanical systems 22 in the disk drive, which in turn affect the PES 23. The FIR adaptation 24 creates another input into the mechanical systems 22.

FIG. 2B is a flowchart illustrating write inhibition in a disk drive using adaptive prediction according to an embodiment the invention. The disk drive is mechanically mounted on the laptop chassis 31 in this embodiment. The unknown time varying disturbances 21 are transmitted to disk drive through the rigid mechanical mounting. The disturbances 21 can typically be music, speech or other sounds generated by a speaker that is also attached to the laptop chassis 31. As the disk drive's servo system attempts to hold the actuator over a track on the rotating disk (track following) for a write operation, the disturbance creates cross track head motion that is detectable in the PES signals generated in the read head and received by the servo system.

The maximum value for the number N of PES samples and corresponding coefficients is limited by computational/memory overhead. In each sector the PES prediction, which will be referred to as EstPES is generated by performing N multiplications/additions. Essentially the FIR filter is trying to adapt/fit the mechanical transfer function between speaker and PES, so the needed number of taps (or N) depends upon the disturbance spectrum. So the optimal N is a function of disturbance, but a practical value of N is one that can provide a good fit in terms of transfer function up through some desired frequency.

The coefficient values can be initialized with predetermined values based on a fixed model, but adaptation will quickly adjust the coefficient to the correct values corresponding to the incoming disturbance. At the time of initialization, PES values may be set to zero. Alternatively a selected number of PES samples can be accumulated before turning on the FIR filter.

In each iteration the method measures the current PES in the conventional way and assigns the value to PES(k) 32. The PES value is a signed number with a positive value representing deviation from a track centerline in one direction and a negative value representing deviation in the opposite direction. The most recent N PES values are saved in memory with the newest one PES(k) pushing the oldest one PES(k−N) out. The array notation X(k) is used herein as a convenience to refer to individual values index by k in a related set of data X that are saved in memory.

After measuring the PES(k) value, the system then determines how much the previous prediction, which will be referred to as EstPES(k), from the prior iteration differs from the newly measured PES(k). The error in previous estimate of the PES, which is a signed number, is calculated as: EstErr(k)=EstPES(k)−PES(k) 33. This error in previous estimate is then used to update the model coefficients (weights) w₁, w₂, . . . w_{N} that are used to adapt to the vibration/disturbance 34. The updating of the coefficients is shown as a dotted line parallel path to indicate that update need not occur for every sample PES. For example, to reduce the computational burden, an embodiment could update the coefficients on a selected schedule such as once for every 2, 3, 4 . . . sectors.

The update uses a selected function such as an LMS algorithm, which will be discussed further below. Thus each iteration of the loop uses the error in previous estimate to adjust the result of the next prediction.

The next prediction EstPES(k+1) is then calculated as:

EstPES(k+1)=w₁PES(k)+w₂PES(k−1)+ . . . +w_{N}PES(k−N+1)35

Thus, the estimate of the future position indexed as “k+1” is made using the actual PES measurements for the most recent N positions, which are stored by the system. The write inhibit decision 36 is then made by determining whether either a) the absolute value of the current PES(k) is less than predetermined value L; or b) the absolute value of the estimate future position EstPES(k+1) is less than predetermined value L. If both the current and future PES values are less than the predetermined limit value L, then writing is allowed 38, otherwise writing is inhibited 37.

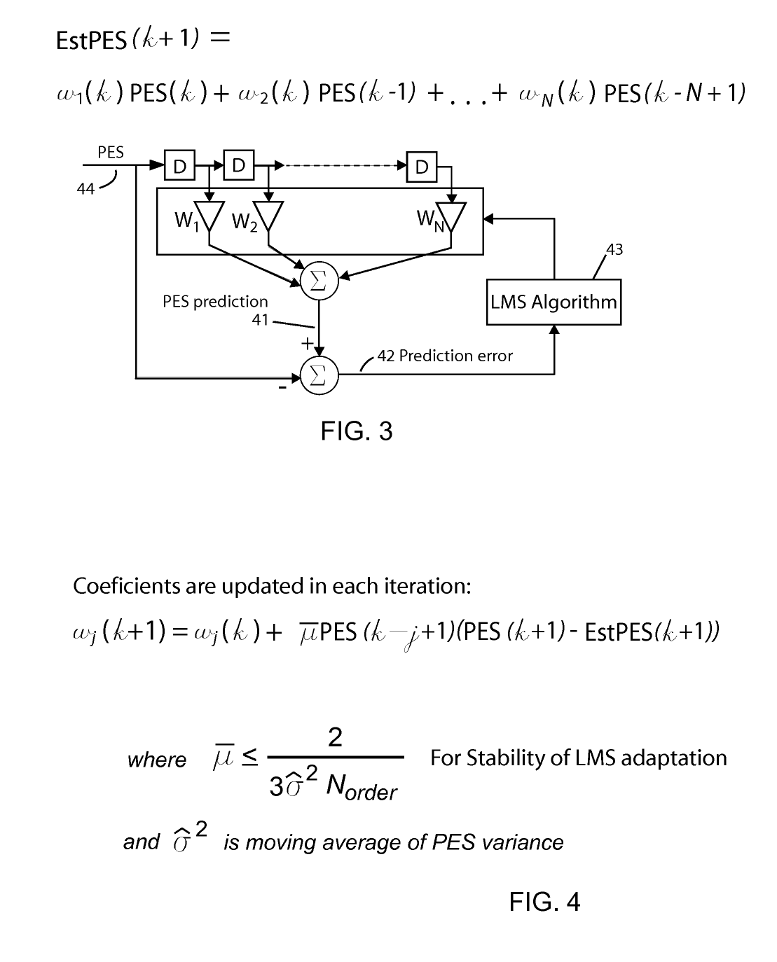

FIG. 3 is a block diagram illustrating an adaptive FIR filter in an adaptive prediction write-inhibit system according to an embodiment the invention. The adaptive FIR filter is used to predict the future head position based on the current head position and the history of the head position. the FIR filter adjusts to transfer function (TF) between the disturbance source through the chassis and to the measured PES.

The general equation describing the output of the FIR predicting the next PES is:

EstPES(k+1)=w₁(k)PES(k)+w₂(k)PES(k−1)+ . . . +w_{N}(k)PES(k−N+1)

The previously saved PES values indexed here as [k . . . k−N+1] are multiplied by the respective filter coefficients and added together.

The FIR filter coefficients w₁,w₂, . . . w_{N} are adjusted in real-time in each iteration in order to minimize prediction error. An embodiment uses a LMS algorithm implemented in the following function:

wⱼ(k+1)=wⱼ(k)+2μPES(k−j+1)(EstErr(k+1)
where: μ (mu) is the learning rate or adaptation rate and EstErr(k+1)=EstPES(k+1)−PES(k+1)
   To ensure the stability of the adaptative algorithm, μ̅ should be lower than a selected limit (further defined in FIG. 4):

$$\overline{μ} \leq \frac{2}{3 {\hat{σ}}^{2} N}$$

However, for faster convergence (and hence effectiveness) faster learning rates should be used. The fixed learning rate used in prior art adaptive schemes (sensor based FF, ANC, APF, etc) may suffer from slow convergence because the learning rate limited. Embodiments of the invention adjust the learning rate as a function of signal power using the inverse of the moving average PES variance.

Mu is found as an inverse function of the moving average \hat{σ}² of the variance of the saved set of PES values. For example,

$$μ = κ \frac{a}{b {\hat{σ}}^{2}}$$

Where a=2, b=3N, and k is set to be smaller than 1.0 (e. g. 0.9).

The prediction error output 42 is generated as described above by determining the difference between the prior PES prediction 41 and the current measured PES 44. The prediction error output 42 is fed back into a least mean squares (LMS) algorithm block 43, which updates the filter coefficients w₁,w₂, . . . w_{N}.

1. A method of operating a disk drive where a first predicted PES value has been previously computed using a set of N coefficients corresponding to a saved series of N most recent PES values, the method comprising:
measuring and saving a current PES value as part of the saved series of PES values;
calculating a prediction error as a difference between the current PES value and the first predicted PES value;
periodically updating the set of coefficients on a selected schedule using the prediction error and an inverse of a moving average of a variance of the saved series of PES values;
determining a second predicted PES value by multiplying each of the saved series of PES values by the corresponding coefficient to generate a set of resulting values and summing the resulting values; and
inhibiting a write operation if either the current PES value or the second predicted PES value is greater than a predetermined value.

2. The method of claim 1 wherein wⱼ refers to a selected coefficient in the set of coefficients and wⱼ(k) refers to a previously set value of wⱼ, EstErr(k+1) is the most recently calculated prediction error and PES(k−j+1) is the saved PES value corresponding to the coefficient wⱼ, and wherein updating the set of coefficients further comprises setting coefficient wⱼ equal to (wⱼ(k)+2μ PES(k−j+1) (EstErr(k+1)), where μ is the learning rate which is inversely proportional to a moving average of the variance of the saved series of PES values.

3. The method of claim 1 wherein the selected schedule updates the set of coefficients once for a predetermined number of measured PES values.

4. A disk drive with a write inhibit function with an adaptive FIR filter including:
a set of N multipliers with inputs for N most recent measured PES values, each multiplier including a coefficient that the corresponding PES value is multiplied by to generate an output;
an adder that sums the outputs of the multipliers to generate a predicted PES value;
means for updating the coefficients using a function of a) a prediction error that is a difference between a next measured PES value and the predicted PES value and b) an inverse of a moving average of a variance of the N most recent measured PES values; and
means for inhibiting a write operation if either the next measured PES value or the predicted PES value is greater than a predetermined value.
